(19) United States
(12) Patent Application Publication
(10) Pub. No.: US 2003/0056185 A1
(43) Pub. Date: Mar. 20, 2003

(54) Semiconductor integrated circuit design method

(75) Inventor: Kazuhiro Nakajima, Tokyo (JP)

Correspondence Address: SCULLY SCOTT MURPHY & PRESSER, PC, 400 GARDEN CITY PLAZA, GARDEN CITY, NY, 11530

(73) Assignee: NEC Corporation, Tokyo (JP)

(21) Appl. No.: 10/244,328

(22) Filed: Sep. 16, 2002

(30) Foreign Application Priority Data
Sep. 17, 2001 (JP) 281830/2001

(51) Int. Cl. G06F 9/45; G06F 17/50

(52) U.S. Cl. 716/5

(57) ABSTRACT

In a semiconductor integrated circuit design method in which a circuit is artificially (preliminarily) configured by carrying out layout and wirings of each of sequential circuits and combinational circuits, and timing specifications of the sequential circuits are checked based on a simulation which confirms the operation of the circuit, several blocks of sequential circuits of the same type with different setup time and hold time and having the same function, block size, terminal number, terminal positions and wiring inhibition information are prepared in advance, a simulation is executed by artificially configuring a semiconductor integrated circuit by layout of each block and wirings between blocks, and the simulation is continued while replacing the arranged sequential circuits by sequential circuits of the same type, until the number of sequential circuits for which clock signal undergoes a change within a prescribed time ceases to decrease, and the margins of the timing specifications stops to increase from the values of the sequential circuits before the replacement.

### BACKGROUND OF THE INVENTION

1. Field of the Invention

The present invention relates to a semiconductor integrated circuit design method, and more particularly to a semiconductor integrated circuit design method in which an artificially (preliminarily) configured semiconductor integrated circuit is operated by simulation to confirm its operation.

1. Description of the Prior Art

In designing a semiconductor integrated circuit consisting of sequential circuits and combinational circuits, it has been necessary conventionally to artificially carry out layout for each block and wirings for each block, of the sequential circuits and the combinational circuits, and check the timing specifications of the sequential circuits by means of a simulation which can confirm the operation of the circuit.

In Japanese Patent Applications Laid Open, No. Hei 10-313057 is disclosed a semiconductor integrated circuit design method in which several blocks of sequential circuits of the same type with different setup time and hold time and having the same function, block size, terminal number, terminal positions and wiring inhibition information are prepared in advance, and the timing margin for each sequential circuit is increased by replacing sequential circuits with small setup margins and the like by sequential circuits with different setup time and hold time, based on a simulation carried out after layout of the blocks and wirings between the blocks.

FIG. 11 is a flow chart showing a conventional semiconductor integrated circuit design method. As shown in FIG. 11, first, a designer configures artificially a semiconductor integrated circuit by carrying out layout of the blocks and wirings between the blocks (step 100). Then, the designer executes simulation of circuit operation for the constituted semiconductor integrated circuit to check the timings for all the sequential circuits on the semiconductor integrated circuit (step 110). Next, the designer calculates margin for the timing specification for each sequential circuit (step 120).

Then, the designer replaces a block having a sequential circuit which does not satisfy the timing specification calculated in step 120 by another block of a sequential circuit having different setup time and hold time (step 130), and carries out the simulation again to check whether the margin of the sequential circuit is increased or not by comparing the result with the margin of the sequential circuit before the replacement (step 150). If found that the margin has been increased, it goes back to step 130, and if found that it is decreased from the margin of the sequential circuit prior to the replacement, the block of the sequential circuit prior to the replacement is reinstated (step 180), and the processing is completed.

FIG. 12 shows circuit diagrams illustrating the configuration of the sequential circuits. As shown in FIG. 12, the sequential circuit has two registers 45 and 46, and four switches 41 to 44 for switching the inputs to these registers. A clock buffer 47 is inserted in the input signal line of the clock signal in the sequential circuit shown in FIG. 12A, a clock buffer 47′ is inserted in the input signal line of the clock signal in the sequential circuit in FIG. 12B, and a clock buffer 47″ is inserted in the input signal line of the clock signal in the sequential circuit in FIG. 12C.

In the sequential circuits in FIG. 12A to FIG. 12C, differences are generated in the setup time due to the differences in configuration such as the gate number of the clock buffers 47 to 47″. The setup time of the sequential circuit in FIG. 12B is longer than the setup time of the sequential circuit in FIG. 12A, and the setup time of the sequential circuit in FIG. 12B is shorter than the setup time of the sequential circuit in FIG. 12C. In the conventional semiconductor integrated circuit design method shown in FIG. 11, in the operation of step 130, the sequential circuit in FIG. 12B is replaced, for example, by the sequential circuit in FIG. 12A, or the like.

In the meantime, in the design of a semiconductor integrated circuit, it is an important point of the design to suppress the increase in the noises, electromagnetic interference (EMI) or the like generated in the circuit. In order to keep the noises and EMI generated by the circuit at a low level, the instantaneous currents in the circuit have to be suppressed to small values.

FIG. 13 is a circuit diagram showing an example of the configuration of the semiconductor integrated circuit. As shown in FIG. 13, the semiconductor integrated circuit comprises sequential circuits 1 to 3 and combinational circuits 4 and 5. A power supply voltage VDD and a clock signal are supplied to each of the sequential circuits 1 to 3, and the sequential circuits 1 to 3 are connected to parallel resistors R1 to R3, respectively. The other ends of respective resistors R1 to R3 are grounded via a resistor R4. Currents flowing in the resistors R1 to R4 are denoted I1 to I4, respectively.

FIG. 14 is a timing chart showing the operation of the semiconductor integrated circuit in FIG. 13. In FIG. 14 are illustrated the changes in the clock signal, internal clock signal B of the sequential circuits 1 to 3, data input to the sequential circuit 2, data input to the sequential circuit 3, the currents I1 to I3 and the current I4. The timing chart is sectioned into units of a prescribed time Δt, and the number of sequential circuits which underwent switching of the clock signal within Δt, namely, the number of sequential circuits for which the clock signal is actuated within Δt, is also entered in the timing chart. Here, the cycle of the clock signal is set at 10 ns, and it will be assumed that the internal clock signal B for the sequential circuits 1 to 3 is delayed by about Δt from the clock signal. As shown in FIG. 14, the internal clock signals B for the sequential circuits 1 to 3 are all switched at an identical operating timing. Since all the currents I1 to I3 flowing in the resistors R1 to R3 reach the highest values at the switching of the internal clock signals B, the current I4 that flows in the resistor R4 undergoes a sudden change and attains its maximum value at that point.

As described in the above, since the current flowing out of the sequential circuit becomes the highest at the time where the on-off of the internal clock signal for the sequential circuit is switched, the current flowing out of the sequential circuits amounts to a very large value if the internal clock signals for a plurality of sequential circuits are switched within a prescribed time, creating a high possibility of generation of noises and EMI from the circuit. In order to alleviate such a possibility, it becomes necessary in the semiconductor integrated circuit design method to distribute the timings for switching the internal clock signals for a plurality of sequential circuits. However, there has been a problem in that it is not possible to distribute the timings of switching of the internal clock signals of a plurality of sequential circuits by the adoption of the conventional semiconductor integrated circuit design method described in the above.

As in the above, since the current flowing out of the sequential circuit reaches a maximum at the point at which the on-off of the internal clock signal for the sequential circuit is switched and the current flowing out of the sequential currents becomes very large if the internal clock signals for a plurality of sequential circuits undergo switching within a prescribed time, the possibility of generation-of noises and EMS from the circuit becomes high. In order to alleviate such a possibility, it is necessary in the design of the semiconductor integrated circuit to distribute the timings for switching the internal clock signals for a plurality of sequential circuits and to meet the timing specifications as well, a semiconductor integrated circuit design method that can satisfy such demands has not been realized in the past.

The present invention aims at providing a semiconductor integrated circuit design method that can satisfy the timing specifications and at the same time can suppress the generation of noises and EMI.

### BRIEF SUMMARY OF THE INVENTION

Object of the Invention

It is the object of the present invention to provide a semiconductor integrated circuit design method that can satisfy the timing specifications, and at the same time can suppress generation of noises and EMI.

Summary of the Invention

In a semiconductor integrated circuit design method in which a circuit is configured by artificially carrying out layout of each block and wiring of each block of sequential circuits and combinational circuits, and checks timing specifications of the sequential circuits based on a simulation which confirms the operation of the circuit, several blocks of the same type with different setup time and hold time and having the same function, block size, terminal number, terminal positions and wiring inhibition information are prepared in advance, and a simulation is carried out by artificially configuring a semiconductor integrated circuit through layout of each block and wirings between various blocks. The simulation is continued by replacing the sequential circuit laid out by a sequential circuit of the same type, until the number of sequential circuits, which undergo clock signal change within a prescribed time, no longer decreases any more, and the margin of the timing specification increases no longer compared with that of the sequential circuit before the replacement of the block.

### BRIEF DESCRIPTION OF THE DRAWINGS

The above-mentioned and other objects, features and advantages of this invention will become more apparent by reference to the following detailed description of the invention taken in conjunction with the accompanying drawings, wherein:

FIG. 1 is a flow chart showing a first embodiment of the semiconductor integrated circuit design method according to the present invention;

FIG. 2 is a circuit diagram showing the configuration of a circuit, including sequential circuits laid out and wired, in step 100 of the first embodiment of the semiconductor integrated circuit design method of the invention;

FIG. 3 is a circuit diagram showing the circuit configuration of the sequential circuit.

FIG. 4 is a timing chart showing the result of simulation in step 110 of the first embodiment of the semiconductor integrated circuit design method of the invention;

FIG. 5 is a circuit diagram showing the configuration of a circuit, including sequential circuits laid out and wired, in steps 130 and 140 of the first embodiment of the semiconductor integrated circuit design method of the invention;

FIG. 6A and FIG. 6B are circuit diagrams showing the configuration of sequential circuits of the same type as the sequential circuits 1 to 3, but have different setup times and hold times;

FIG. 7A and FIG. 7B are circuit diagrams showing the configuration of sequential circuits of the same type as the sequential circuits 1 to 3, but have different setup times and hold times;

FIG. 8 is a timing chart showing the result of a simulation in step 150 of the first embodiment of the semiconductor integrated circuit design method of the invention;

FIG. 9 is a flow chart showing a second embodiment of the semiconductor integrated circuit design method of the invention;

FIG. 10 is graphs showing the variations in the sum of current consumption by the clock signals of the sequential circuits before and after step 150 of the second embodiment of the semiconductor integrated circuit design method of the invention;

FIG. 11 is a flow chart showing a conventional semiconductor integrated circuit design method;

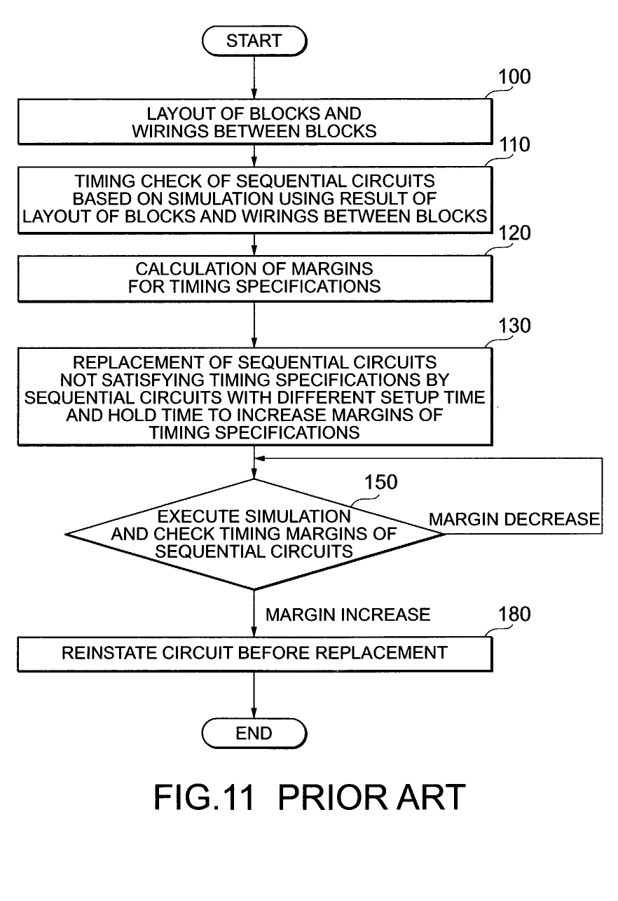

FIG. 12A to FIG. 12C are circuit diagrams showing the configuration of the sequential circuits;

FIG. 13 is a circuit diagram showing an example of the configuration of the semiconductor integrated circuit; and

FIG. 14 is a timing chart showing the operation of the semiconductor integrated circuit in FIG. 13.

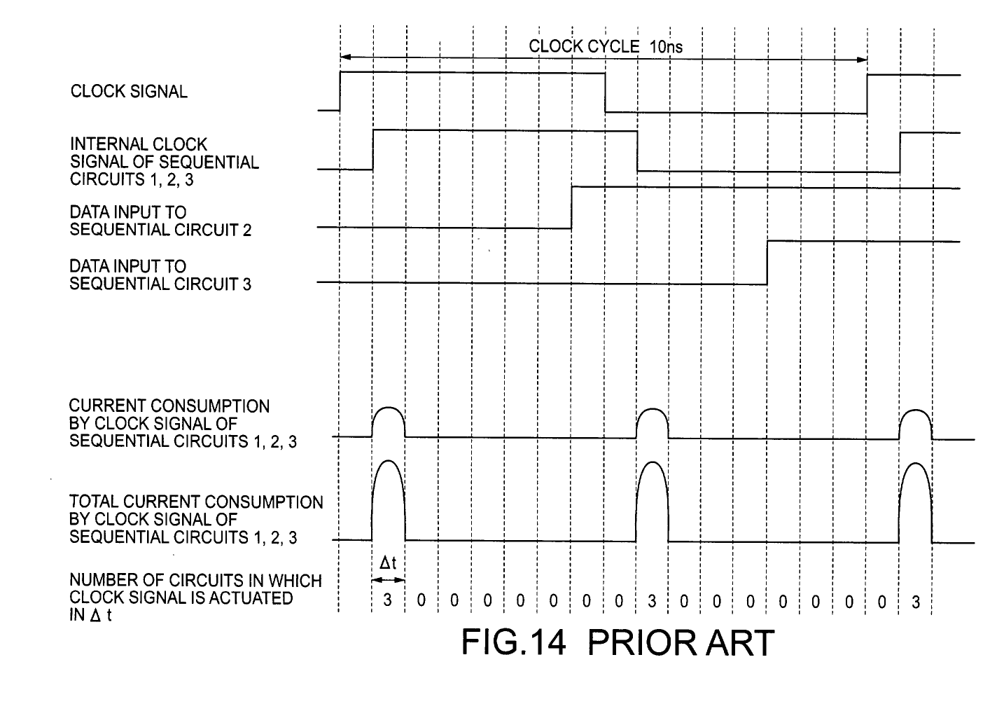

### DETAILED DESCRIPTION OF THE INVENTION

Referring to the drawings, the semiconductor integrated circuit design method according to the present invention will be described in detail. In all of the drawings, constituent elements with the same symbols show identical elements.

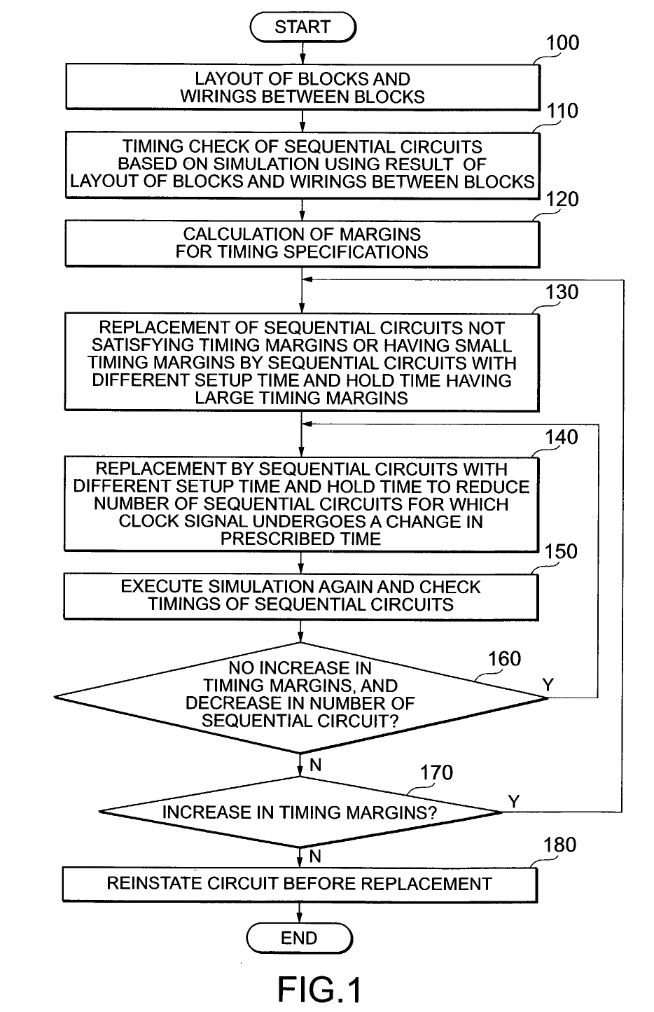

To begin, the first embodiment of the semiconductor integrated circuit design method of the invention will be described. FIG. 1 is a flow chart showing the semiconductor integrated circuit design method of this embodiment. In the semiconductor integrated circuit design method of this embodiment, a plurality of the same type of blocks of the sequential circuits having equal function, block size, terminal number, terminal positions and wiring inhibition information and different setup time and hold time are prepared in advance. As shown in FIG. 1, the designer first configures artificially a semiconductor integrated circuit by laying out blocks and wiring between the blocks (step 100). Next, the designer executes operational simulation of the circuit for the semiconductor integrated circuit configured, and checks the timings for all the sequential circuits on the semiconductor integrated circuit (step 110). The designer then calculates the margin for the timing specification of each sequential circuit (step 120).

The designer then replaces a sequential circuit which does not satisfy the timing specification, or has a small timing margin by a block of sequential circuit of the same type with different setup time and hold time based on the margin calculated in step 120 (step 130).

Next, the designer replaces the laid sequential circuit by a sequential circuit of the same type having different setup time and hold time to reduce the number of sequential circuits which undergo clock signal change within a prescribed time (step 140), and executes a simulation again to check the timing of the sequential circuit (step 150).

When the timing margin does not increase and the number of sequential circuits that underwent change in the clock signal within the prescribed time decreased in the simulation executed in step 150, compared with the values before the replacement of the sequential circuit, it goes back to step 140, and proceeds to step 170 otherwise (step 160).

In step 170, it is checked whether or not the timing margin is increased compared with the situation before the replacement of the sequential circuit. When the timing margin is increased, it goes back to step 130, and proceeds to step 180 otherwise. In step 180, the sequential circuit laid out is replaced by the sequential circuit before the replacement, and the processing is completed.

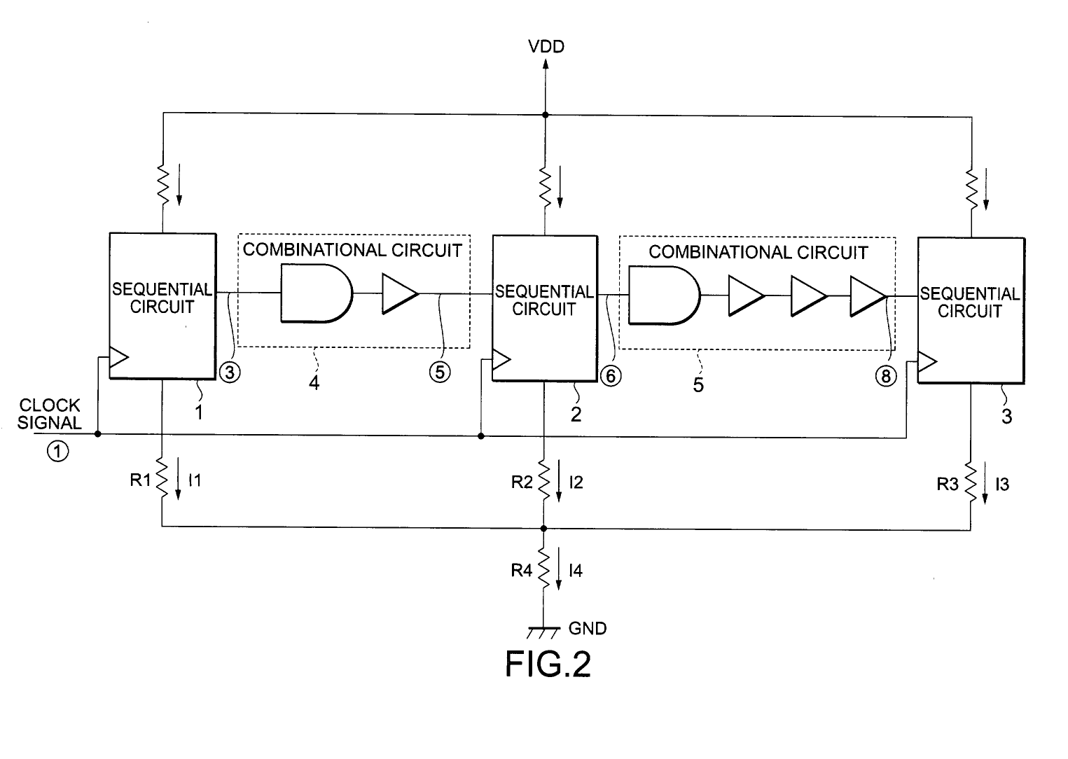

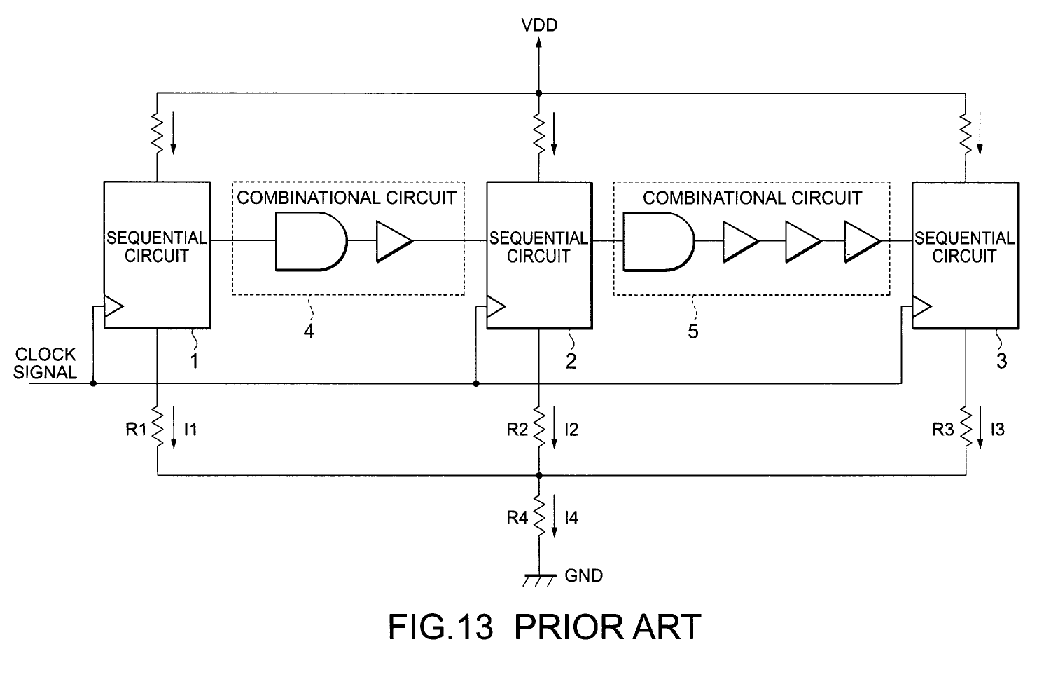

FIG. 2 is a circuit diagram showing the configuration of the circuit including the sequential circuits which have been laid out and wired in step 100 of the semiconductor integrated circuit design method of the invention. The circuit shown in FIG. 2 has the same configuration as the circuit in FIG. 13, where the sequential circuits 1 to 3 are arranged. A clock signal is supplied distributively to the sequential circuits 1 to 3. Output data of the sequential circuit 1 is input to the sequential circuit 2 via a logic circuit 4. Output data of the sequential circuit 2 is input to the sequential circuit 3 via a logic circuit 5. A power supply voltage VDD is supplied to each of the sequential circuits 1 to 3. For the purpose of reference in the later description, the clock signal, data output from the sequential circuit 1, data input to the sequential circuit 2, data output from the sequential circuit 2 and data input to the sequential circuit 3 are given symbols \mathring{1}, \mathring{3}, \mathring{5}, \mathring{6} and \mathring{8}, respectively.

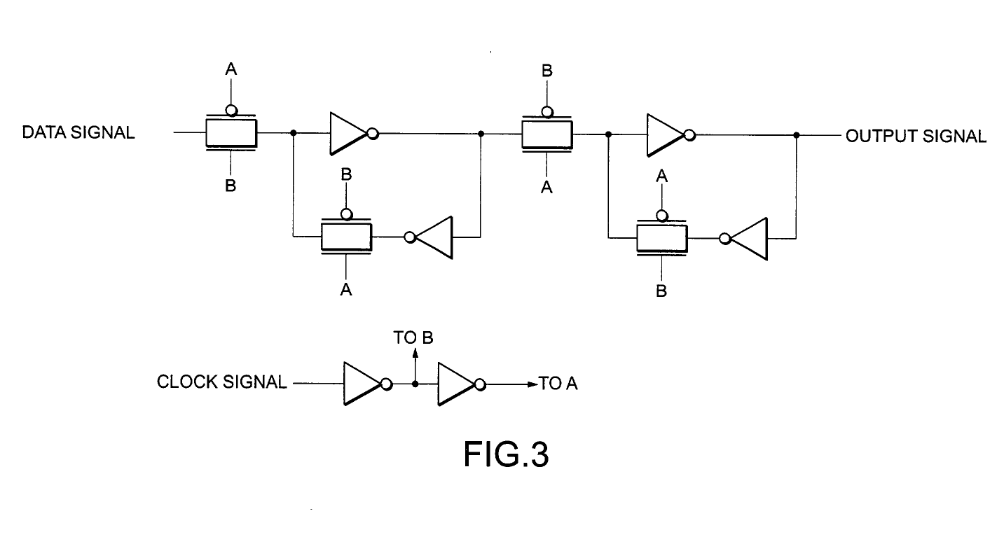

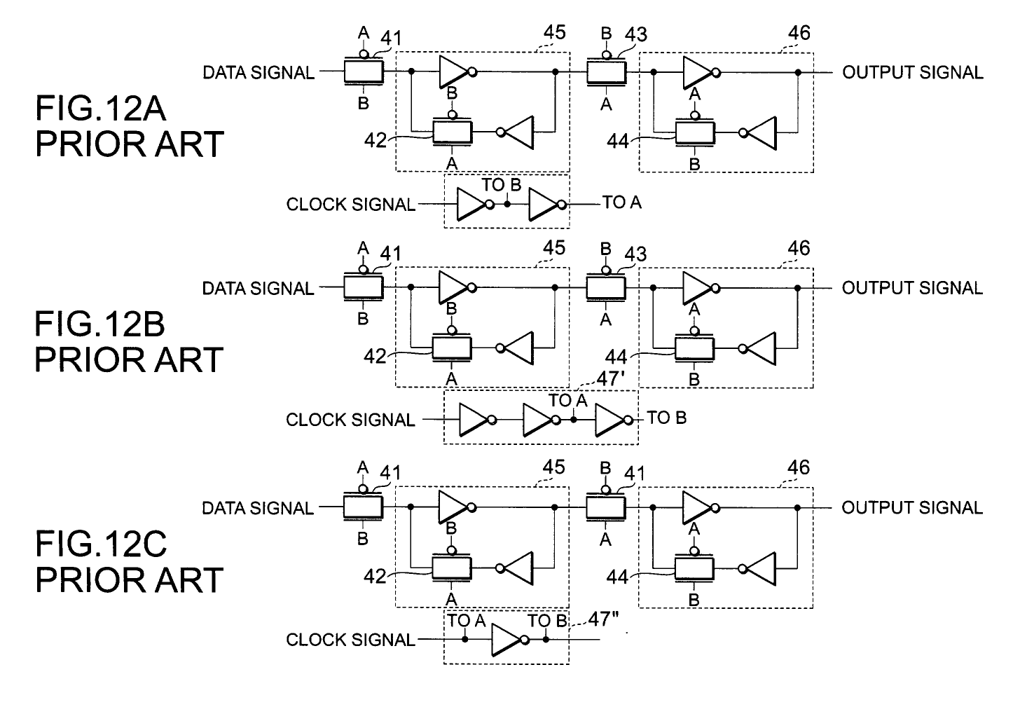

FIG. 3 is a circuit diagram showing the circuit configuration of the sequential circuits 1 to 3. As shown in FIG. 3, the sequential circuits 1 to 3 have the same configuration as the sequential circuits in FIG. 12A, and are constituted by a slave latch and a master latch.

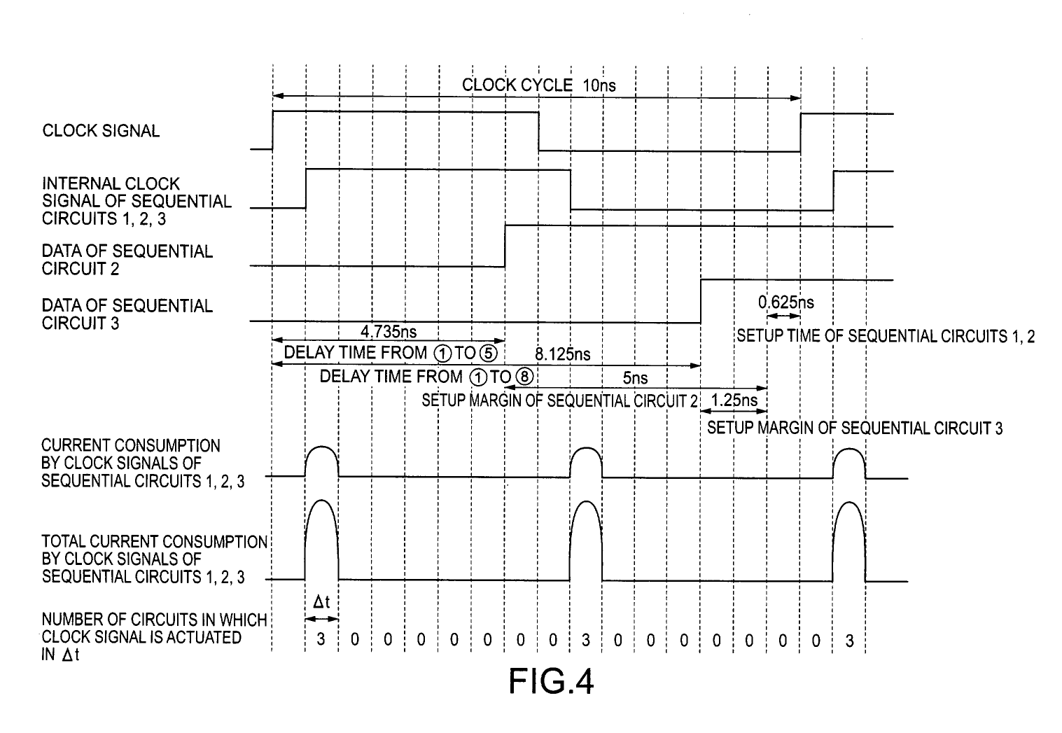

FIG. 4 is a timing chart showing the result, for the circuit shown in FIG. 2, of the simulation in step 110 of the semiconductor integrated circuit design method of this embodiment. In FIG. 4, there are shown from the top of the figure, the clock signal \mathring{1}, the internal clock signal B of the sequential circuits 1 to 3, the data \mathring{5} input to the sequential circuit 2, the data \mathring{8} input to the sequential circuit 3, the current consumptions I1 to I3 by the clock signals of the sequential circuits 1 to 3, the sum I4 of the current consumptions, and the number of sequential circuits for which the clock signal is changed within a prescribed time Δt. The time Δt is the setup time of the sequential circuits 1 to 3 which is set at 0.625 ns, and the cycle of the clock time is set at 10 ns.

As shown in FIG. 4, the delay time from the input of the clock signal \mathring{1} to the input of the data \mathring{5} to the sequential circuit 2 is 4.735 ns, and the delay time from the input of the clock signal \mathring{1} to the input of the data \mathring{8} to the sequential circuit 3 is 8.125 ns. In this case, in the sequential circuit 2, the setup margin is 5 ns against the setup time of 0.625 ns, so that the timing specification is satisfied. In addition, in the sequential circuit 3, the setup margin is 1.25 ns against the setup time of 0.625 ns, and the timing specification is satisfied.

Moreover, since the operation timings of input to the sequential circuits 1 to 3 are simultaneous in this circuit, the number of sequential circuits for which the clock signal is actuated in a certain time Δt is 3 at the most at that timing. The current consumptions I1 to I3 of the sequential circuits 1 to 3 become large at that timing, and their sum I4 attains a maximum at that timing as a result.

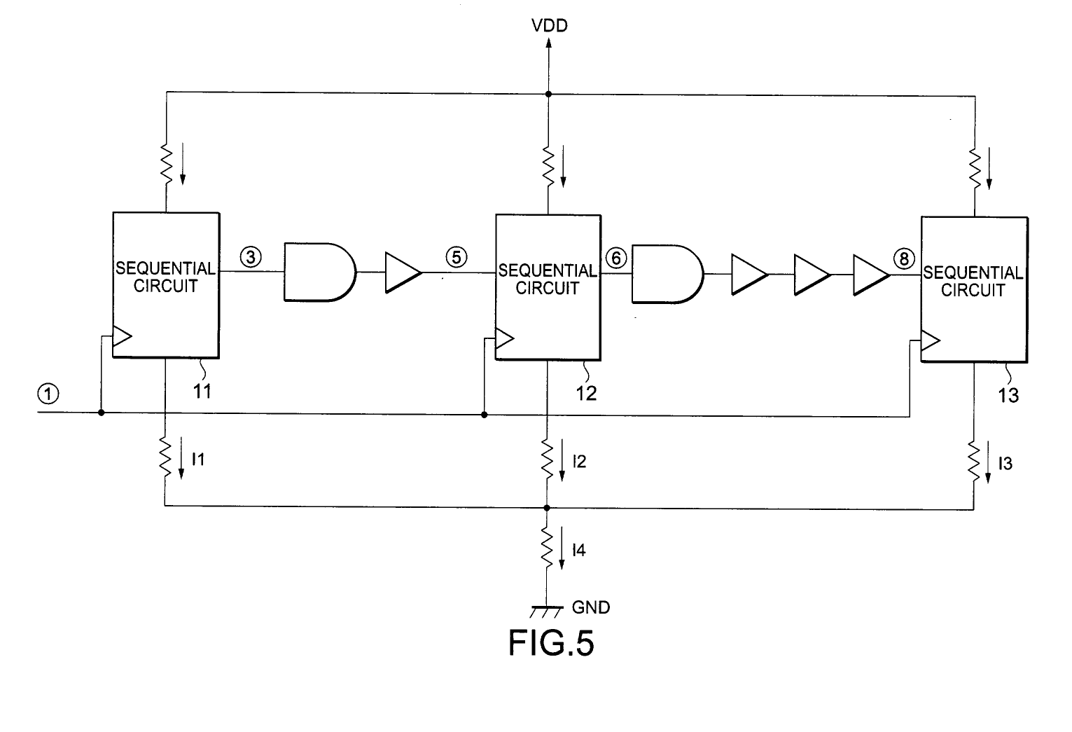

In the semiconductor integrated circuit design method according to this embodiment, the check in the above is carried out instep 110 and step 120, and replaces the sequential circuits 1 to 3 by sequential circuits of the same type having different setup times and hold times in step 130 and step 140. FIG. 5 is a circuit diagram showing the configuration of a circuit including sequential circuits that are arranged and wired in step 130 and step 140 of the semiconductor integrated circuit design method of this embodiment. The circuit shown in FIG. 5 is obtained by replacing the sequential circuit 2 by a sequential circuit 12 with a setup time of 1.25 ns and a hold time of 0 ns, and the sequential circuit 3 is replaced by a sequential circuit 13 with a setup time of 0 ns and a hold time of 1.25 ns.

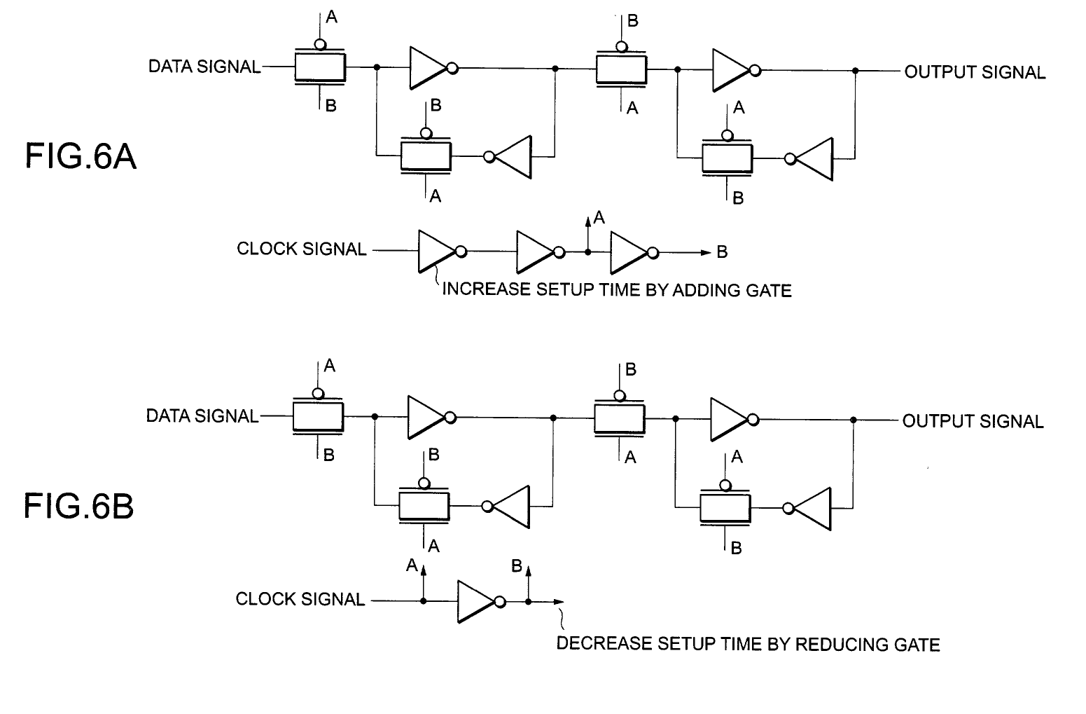

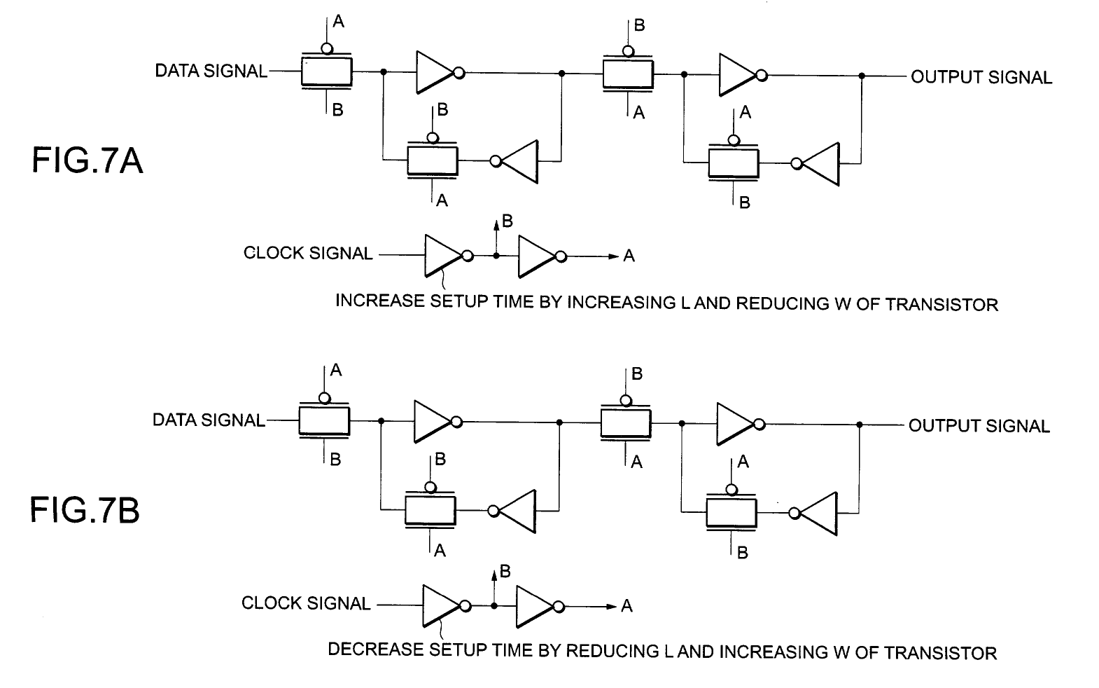

FIG. 6 and FIG. 7 are circuit diagrams showing the configuration of the sequential circuits 1 to 3 and sequential circuits of the same type with different setup time and the hold time used in the semiconductor integrated circuit design method of this embodiment. In FIG. 6A is shown a sequential circuit having a setup time smaller than that of the sequential circuits 1 to 3. In this sequential circuit, a gate is newly inserted in the input signal line of the clock signal in order to reduce the setup time. In addition, in FIG. 6B is shown a sequential circuit having a setup time larger than the sequential circuits 1 to 3. In this sequential circuit, the number of gates inserted in the input signal line of the clock signal is reduced by one in order to increase the setup time.

In FIG. 7A is shown a sequential circuit having a setup time smaller than the sequential circuits 1 to 3. In this sequential circuit, the gate length L of the transistor inserted in the input signal line of the clock signal is set larger, and its gate width W is set smaller in order to reduce the setup time. Moreover, in FIG. 7B is shown a sequential circuit having a setup time larger than those of the sequential circuits 1 to 3. In this sequential circuit, the gate length L of the transistor inserted in the input signal line of the clock signal is set smaller, and its gate width W is set larger in order to increase the setup time. It should be noted that the adjustment of the setup time shown in FIG. 7 is relatively easier to design than the adjustment of the setup time shown in FIG. 6.

According to the semiconductor integrated circuit design method of this embodiment, the sequential circuits are replaced, and the circuit operation is simulated again in step 150 as described in the above.

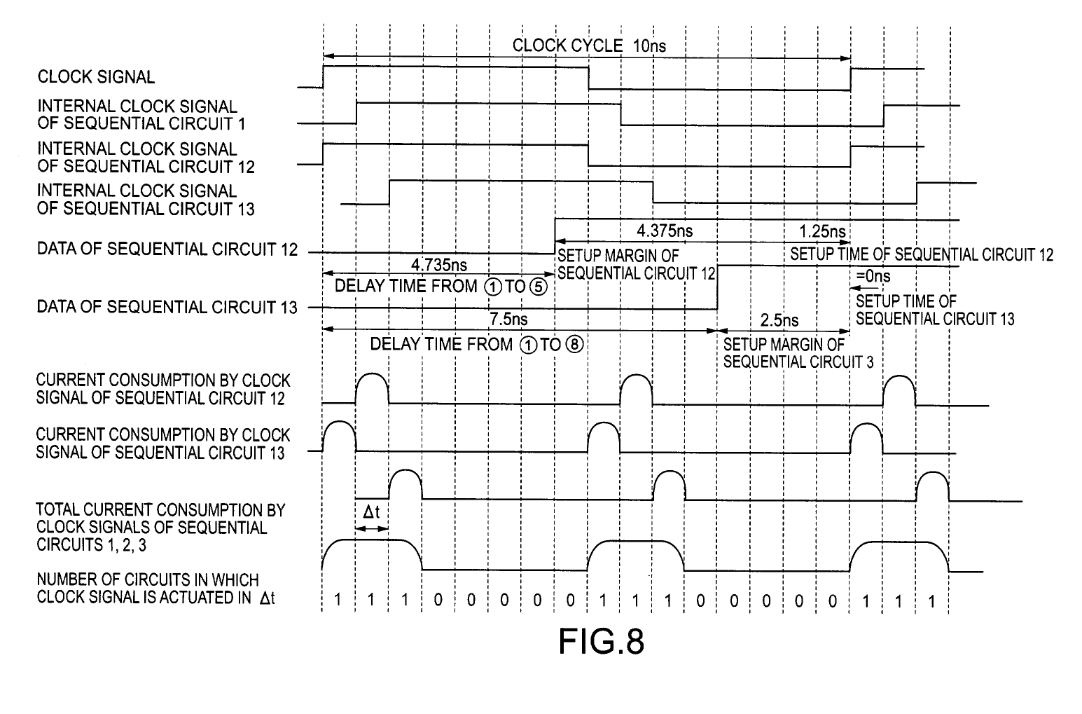

FIG. 8 is a timing chart showing the result of simulation, on the circuit shown in FIG. 5, in step 150 of the semiconductor integrated circuit design method of this embodiment. In FIG. 8, there are shown from the top of the figure, the clock signal \mathring{8}, an internal clock signal A of the sequential circuit 1, the internal clock signal A of the sequential circuit 12, the internal clock signal A of the sequential circuit 13, data \mathring{5} input to the sequential circuit 12, data\mathring{8} input to the sequential circuit 13, the current consumption I1 by the clock signal of the sequential circuit 1, the current consumption I2 by the clock signal of the sequential circuit 12, the current consumption I3 by the clock signal of the sequential circuit 13, the sum I4 of the current consumptions I1 to I3 and the number of sequential circuits whose clock signal is actuated within the prescribed time Δt. The time Δt is set at the setup time 0.625 ns of the sequential circuit 1, and the cycle of the clock signal is set at 10 ns.

As shown in FIG. 8, the delay time from the input of the clock signal \mathring{1} to the input of the data \mathring{5} to the sequential circuit 12 is 4.735 ns, and the delay time from the input of the clock signal \mathring{1} to the input of the data \mathring{8} to the sequential circuit 13 is 7.5 ns. In this case, the sequential circuit 12 has a setup margin of 4.375 ns against the setup time of 1.25 ns and satisfies the timing specification, and the sequential circuit 13 has a setup margin of 2.5 ns against the setup time of 0 ns, so it also satisfies the timing specification.

Moreover, since the operation timings of the internal clock signal A of the sequential circuits 1, 12 and 13 are different, the maximum number of the sequential circuits for which the clock signal is actuated within Δt is 1, and the timings of the peak of the current consumptions I1, I2 and I3 are respectively different. Accordingly, the largest value of the sum I4 of the current consumptions I1, I2 and I3 is about ⅓ of the largest value of I4 shown in FIG. 4, with a result that the circuit shown in FIG. 5 can reduce noises generation and EMI caused by the current consumption, compared with the circuit shown in FIG. 2.

As described in the above, according to the semiconductor integrated circuit design method of this embodiment, several blocks of the same type of sequential circuits with different setup time and hold time, and having the same function, block size, terminal number, terminal positions and wiring inhibition information are prepared in advance, and the timing specification for each sequential circuit is satisfied by replacing sequential circuits that fail to satisfy the timing specifications by a sequential circuit with different setup time and hold time, based on the result of simulation after block layout and wirings between the blocks. In this way, it is possible to let the sequential circuits satisfy their respective timing specifications without changes in the circuit, or correction of the layout of the blocks or the wirings between the blocks. Furthermore, since the sequential circuits can be replaced so as to reduce the number of sequential circuits that undergo change in the clock signal within a prescribed time, according to the semiconductor integrated circuit design method of this embodiment, it is possible to reduce generation of noises and EMI caused by the currents flowing in the circuit.

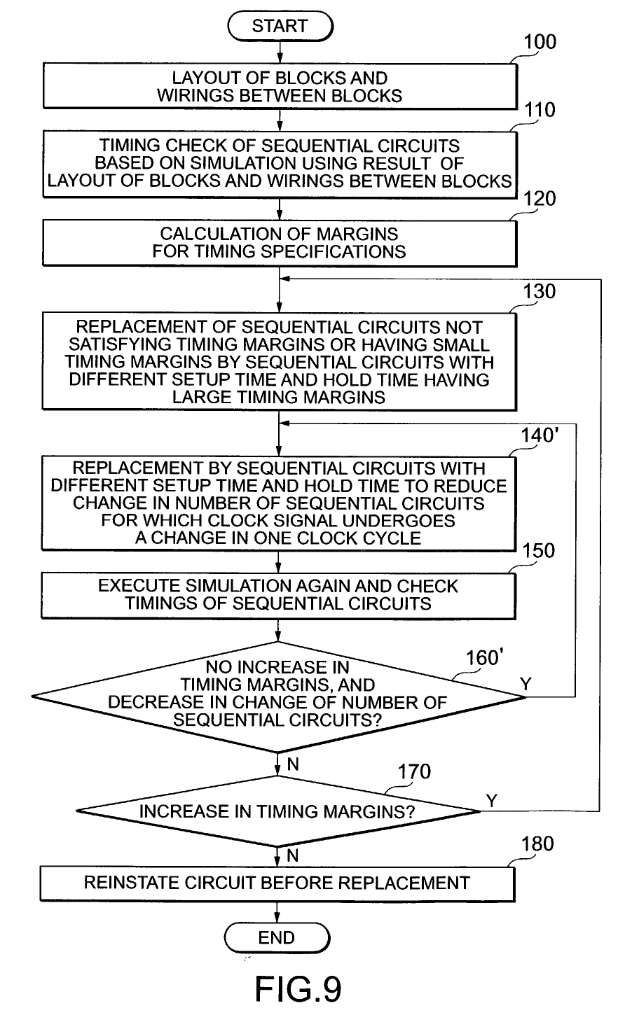

Next, a second embodiment of the semiconductor integrated circuit design method according to the present invention will be described. FIG. 9 is a flow chart showing the semiconductor integrated circuit design method of this embodiment. As shown in FIG. 9, the semiconductor integrated circuit design method of this embodiment differs from the first semiconductor integrated circuit design method in that operations of steps 140′ and 160′ are introduced in place of the operations of the steps 140 and 160 shown in FIG. 1.

In the step 140′, the designer replaces the arranged sequential circuits by sequential circuits of the same type with different setup time and the hold time in order to reduce the change in the number of sequential circuits that undergo clock signal change within the prescribed time. In step 160′, if the result of simulation instep 150′ shows no increase in the timing margin and shows a decrease in the change of the number of sequential circuits that underwent clock signal change within the prescribed time, in comparison with the situation before the replacement of the sequential circuits, it goes back to step 140′, and it proceeds to step 170 otherwise.

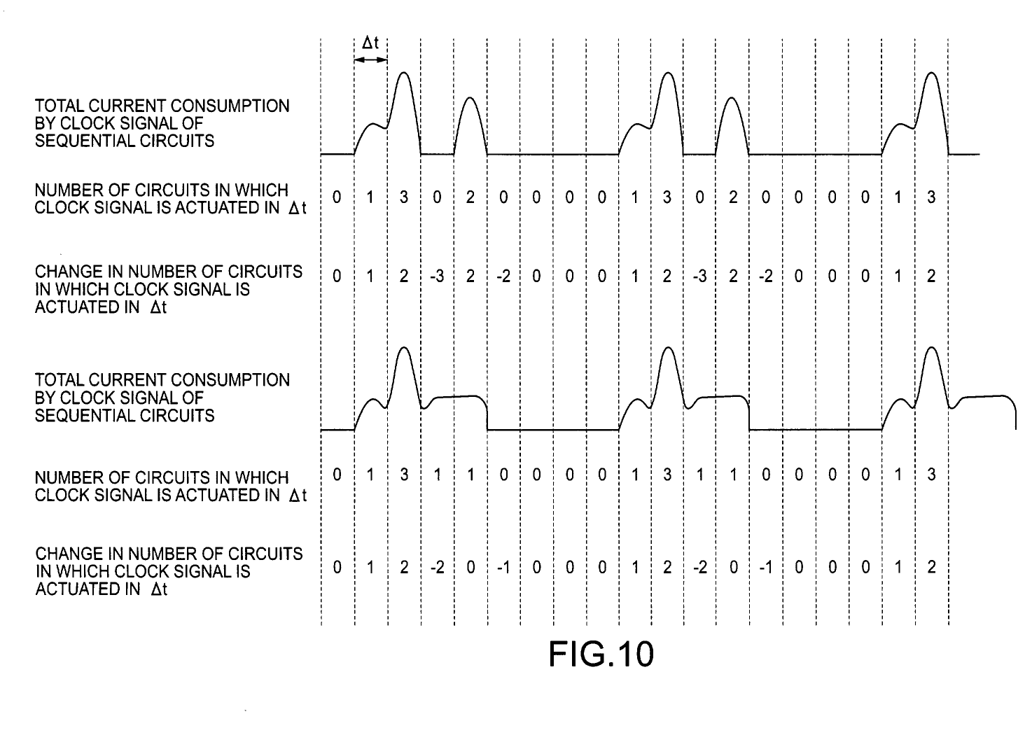

FIG. 10 shows graphs illustrating the variations in the sum of the current consumptions due to clock signal of the sequential circuits before and after execution of step 140′. FIG. 10A shows the sum I4 of the current consumptions, and the number of sequential circuits for which the clock signal is actuated within the time Δt before the execution of step 140′, and FIG. 10B shows the sum I4 of the current consumptions, and the number of sequential circuits for which the clock signal is actuated within Δt. after the execution of step 140′. As shown in FIG. 10A, before the execution of step 140′, the maximum of the number of sequential circuits for which the clock signal is actuated per Δt is 3, and the maximum of the change in such number is also +3 (or 3). In contrast, as shown in FIG. 10B, after execution of step 140′, although the maximum value of the number of sequential circuits for which the clock signal is actuated per Δt remains at the same number of 3, the maximum of the change in such number is +2 (or 2), showing a decrease in the change of such number compared with the situation before execution of step 140′.

As in the above, according to the semiconductor integrated circuit design method of this embodiment, it is possible to decrease the change in the number of sequential circuits for which the clock signal is actuated per certain short prescribed time. Accordingly, in a circuit designed by the semiconductor integrated circuit design method of this embodiment, the change in the currents flowing in the circuit as a whole can be reduced. As a result, in the semiconductor integrated circuit design method of this embodiment, it is possible to further reduce noise generation and EMI beyond those by the first embodiment of the semiconductor integrated circuit design method.

In summary, according to the semiconductor integrated circuit design method of this invention, several blocks of sequential circuits of the same type with different setup time and hold time and having the same function, block size, terminal number, terminal positions and wiring inhibition information are prepared in advance, and respective sequential circuits are made to satisfy the timing specifications by replacing sequential circuits that do not satisfy the timing specifications by sequential circuits with different setup time and hold time, based on the result of a simulation executed after block layout and wirings between the blocks. In this way, the sequential circuits can be made to satisfy the timing specifications without changes in the circuit, and without corrections to the layout of the blocks or the wirings between the blocks. Moreover, according to the semiconductor integrated circuit design method of this invention, since the sequential circuits can be replaced so as to decrease the number of sequential circuits whose clock signals undergo changes within a prescribed time, it is possible to reduce the generation of noises and EMI caused by the currents flowing in the circuit without changes in the circuit, and corrections to the layout of the blocks or the wirings between the blocks.

As a result of the effects in the above, according to the semiconductor integrated circuit design method of this invention, it is possible to satisfy the timing specifications without requiring changes in the circuit, and corrections to the block layout and wirings between the blocks, and decrease the design time of a circuit that is reduced in noise generation and EMI. Furthermore, since the timing margins are adjusted by replacing sequential circuits using sequential circuits with different setup time and hold time, circuit design for satisfying the timing specifications is facilitated even if the skew in the clock distribution is large.

Although the invention has been described with reference to specific embodiments, this description is not meant to be construed in a limited sense. Various modifications of the disclosed embodiments will become apparent to persons skilled in the art upon reference to the description of the invention. It is therefore contemplated that the appended claims will cover any modifications or embodiments as fall within the true scope of the invention.

What is claimed is:

1. In a semiconductor integrated circuit design method in which a circuit is configured artificially (preliminarily) through layout and wirings of each block of sequential circuits and combinational circuits, and timing specifications of said sequential circuits are checked based on a simulation which confirms the operation of said circuit, the semiconductor integrated circuit design method comprising,
a step of preparing in advance several blocks of sequential circuits of the same type with different setup time and hold time and having the same function, block size, terminal number, terminal positions and wiring inhibition information,
a step of executing said simulation by artificially configuring a semiconductor integrated circuit through layout of each of said blocks and wirings between said blocks, and
a step of repeating said simulation while replacing arranged sequential circuits by said sequential circuits of the same type until the number of the sequential circuits for which clock signal undergoes a change within a prescribed time ceases to decrease and the margins of timing specifications stop to increase compared with the values of the sequential circuits before the replacement.

2. In a semiconductor integrated circuit design method in which a circuit is configured artificially through layout and wirings of each block of sequential circuits and combinational circuits, and timing specifications of said sequential circuits are checked by a simulation which confirms the operation of said sequential circuits, the semiconductor integrated circuit design method comprising,
a step of preparing in advance several blocks of sequential circuits of the same type with different setup time and hold time and having the same function, block size, terminal number, terminal positions and wiring inhibition information,
a step of executing said simulation by artificially configuring a semiconductor integrated circuit through layout of each of said blocks and wirings between said blocks, and
a step of repeating said simulation while replacing arranged sequential circuits by said sequential circuits of the same type until the change in the number of sequential circuits for which clock signal undergoes a change within a prescribed time ceases to decrease and the margins of the timing specifications stops to increases compared with the values of the sequential circuits before the replacement.

3. The semiconductor integrated circuit design method as claimed in claim 1 or 2, wherein a plurality of said sequential circuits of the same type with different setup time and hold time are prepared by changing the number of gates inserted in the input signal line of the clock signal.

4. The semiconductor integrated circuit design method as claimed in claim 1 or 2, wherein a plurality of said sequential circuits of the same type with different setup time and hold time are prepared by changing the gate length and the gate width of the transistors inserted in the input signal line of the clock signal.
